(19) United States
(12) Patent Application Publication
(10) Pub. No.: US 2026/0292533 A1
(43) Pub. Date: Sep. 24, 2026

(54) BEAM SWEEPING FACTOR REDUCTION FOR ENHANCED RADIO RESOURCE MANAGEMENT

(71) Applicant: Apple Inc., Cupertino, CA (US)

(72) Inventors: Jie Cui, San Jose, CA (US); Dawei Zhang, Saratoga, CA (US); Yang Tang, San Jose, CA (US); Qiming Li, Beijing (CN); Haitong Sun, Cupertino, CA (US); Chunxuan Ye, San Diego, CA (US)

(21) Appl. No.: 19/472,957

(22) PCT Filed: Apr. 7, 2023
(86) PCT No.: PCT/CN2023/086979

§ 371 Date: Oct. 6, 2025

(51) Int. Cl. H04W 16/28; H04W 8/24; H04W 24/08

(52) U.S. Cl. CPC H04W 16/28; H04W 8/24; H04W 24/08

(57) ABSTRACT

A user equipment (UE) includes a transceiver and a processor. The processor is configured to determine, for a 3rd Generation Partnership Project (3GPP) new radio (NR) frequency range two (FR2) unknown secondary cell (SCell) activation, a first beam sweeping factor for a cell detection part of a Layer 3 (L3) measurement and a second beam sweeping factor for a Layer 1 (L1) reference signal received power (RSRP) (L1-RSRP) measurement. The processor is also configured to report, to a network and via the transceiver, a UE capability. The UE capability identifies a beam sweeping factor pair including the first beam sweeping factor and the second beam sweeping factor.

### TECHNICAL FIELD

This application relates generally to wireless communication systems, including systems in which a user equipment (UE) communicates in a 3rd Generation Partnership Project (3GPP) new radio (NR) frequency range two (FR2) and performs radio resource management (RRM) functions using one or multiple receive (Rx) beams.

### BACKGROUND

Wireless mobile communication technology uses various standards and protocols to transmit data between a network device (e.g., a base station, a radio head, etc.) and a wireless communication device. Wireless communication system standards and protocols can include, for example, 3GPP long term evolution (LTE) (e.g., 4G), 3GPP NR (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 shows an example method of wireless communication by a UE, according to embodiments described herein.

FIG. 3 shows another example method of wireless communication by a UE, according to embodiments described herein.

FIGS. 4 and 5 illustrate example coarse and fine beam refinements by a UE, according to embodiments described herein.

FIG. 6 shows another example method of wireless communication by a UE, according to embodiments described herein.

FIG. 7 shows an example method of wireless communication by a network device, according to embodiments described herein.

FIG. 8 illustrates an example architecture of a wireless communication system, according to embodiments described herein.

FIG. 9 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In some cases, a UE that needs to perform measurements for beam training, for 3GPP NR FR2 unknown secondary cell (SCell) activation, may report a beam sweeping factor (e.g., a first beam sweeping factor) for the cell detection part of a Layer 3 (L3) measurement and/or a beam sweeping factor (e.g., a second beam sweeping factor) for a Layer 1 (L1) reference signal received power (RSRP) (L1-RSRP) measurement. The beam sweeping factor(s) may be used to reduce the number of receive (Rx) beams that the UE needs to train, thereby reducing the duration of the measurement period that the UE needs to perform beam training for L3/L1 measurements and reducing the time that a network needs to wait before scheduling the UE. Typically, the number Rx beams that is used for the cell detection part of the L3 measurement, and for the L1-RSRP measurement, is eight. However, in some cases, a UE may be able to reduce the number of Rx beams used for one or both measurements.

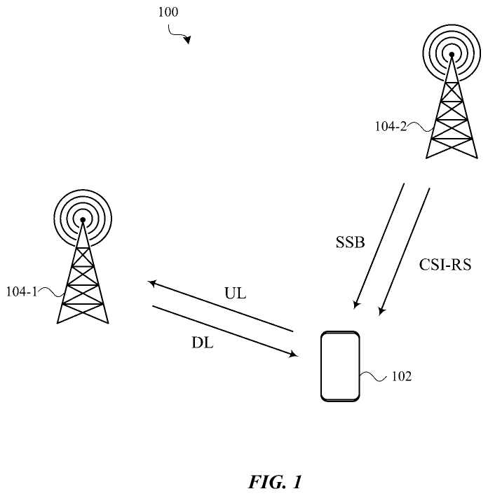

FIG. 1 shows an example wireless communications system 100. The wireless communications system may include a UE 102 that is connected, over the air, to a network (e.g., a 3GPP network). The UE 102 may communicate with the network on one or more uplink (UL) channels and one or more downlink (DL) channels, and more particularly may communicate with one or more network devices of a RAN (e.g., network device 104-1 and/or 104-2, which may take the form of one or more base stations (e.g., gNBs), remote radio heads, etc.) on the one or more UL channels and DL channels. Depending on the capabilities of the UE 102 and the UE's configuration by the network, the UE 102 may communicate with the one or more network devices 104-1, 104-2 simultaneously, contemporaneously (e.g., in a multiple input multiple output (MIMO) mode), or sequentially (e.g., when handed over).

In some cases, the UE 102 may be connected to a first network device 104-1 in a radio resource control (RRC) connected mode state, and a second network device 104-2 may belong to a neighbor cell of the cell containing the first network device 104-1. In some embodiments, the neighbor cell may be a candidate SCell for the UE 102. For RRM purposes (e.g., mobility management), the UE 102 may measure one or more signals (e.g., a channel state information (CSI) reference signal (RS) (CSI-RS) and/or a synchronization signal block (SSB)) transmitted by the second network device 104-2.

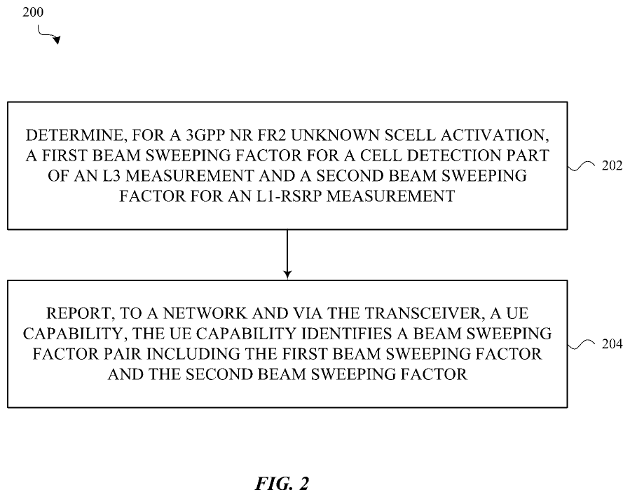

FIG. 2 shows an example method 200 of wireless communication by a UE. In some cases, the UE may be the UE described with reference to FIG. 1 or one of the other UEs described herein. The method 200 may be performed using a processor, a transceiver, or other components of the UE.

At 202, the method 200 may include determining, for a 3GPP NR FR2 SCell activation, a first beam sweeping factor (X1) for a cell detection part of an L3 measurement, and a second beam sweeping factor (X2) for an L1-RSRP measurement.

At 204, the method 200 may include reporting, to a network (e.g., to a network device of a RAN, such as a base station or gNB) and via the transceiver, a UE capability. The UE capability may identify a beam sweeping factor pair (X1, X2) including the first beam sweeping factor and the second beam sweeping factor.

The method 200 may be variously embodied, extended, or adapted, as described in the following paragraphs and elsewhere in this description.

In some embodiments of the method 200, the first beam sweeping factor may be a member of a first list of candidate options (e.g., X1∈{n₁, n₂, n₃. . . } . In some embodiments, each candidate option in the first list of candidate options may be less than or equal to eight (e.g., n₁ <n₂<n₃. . . ≤8). In some embodiments, the second beam sweeping factor may be a member of a second list of candidate options (e.g., X2∈{m₁, m₂, m₃. . . } . In some embodiments, each candidate option in the second list of candidate options may be less than or equal to eight (e.g., m₁<m₂ <m₃. . . ≤8). In some embodiments, the number of candidate options in each list of candidate options may be greater or fewer.

In some embodiments of the method 200, the first list of candidate options may include four or fewer candidate options and the second list of candidate options may include four or fewer candidate options (e.g., when the reported beam sweeping factor pair is (X1, X2), X1=nᵢ, and X2=mⱼ, then 1≤i, j≤4). With such a limitation, the number of possible beam sweeping factor pairs is sixteen. In other embodiments, each list of candidate options may include more or fewer candidate options, and the number of possible beam sweeping factor pairs may be greater or fewer. However, a network device (e.g., a network device of a RAN) must have the resources to support the number of possible beam sweeping factor pairs.

In some embodiments of the method 200, the first beam sweeping factor and the second beam sweeping factor may be determined under the constraint that the first beam sweeping factor must be less than the second beam sweeping factor (i.e., X1<X2). In other embodiments, the first beam sweeping factor and the second beam sweeping factor may be determined under the constraint that the second beam sweeping factor must be less than the first beam sweeping factor (i.e., X2<X1). In other embodiments, the first beam sweeping factor and the second beam sweeping factor may be determined under the constraint that the first beam sweeping factor must be equal to the second beam sweeping factor (i.e., X1=X2).

In some embodiments, the method 200 may include mapping the beam sweeping factor pair to an index. In these embodiments, reporting the UE capability, at 204, may include reporting the index. For example, an index s may be defined such that sₖ={nᵢ, mⱼ} for 1≤i, j≤4 and 1≤k≤16. Reporting an index may reduce the number of bits that need to be transmitted to a network to indicate a beam sweeping factor pair to the network.

In some embodiments of the method 200, the UE capability may be a capability indication based on 3GPP Technical Specification (TS) 38.306. For example, and in some embodiments, the beam sweeping factor pair may be associated with the UE (i.e., the beam sweeping factor pair may be a per-UE beam sweeping factor pair). In some embodiments, the beam sweeping factor pair may be associated with an FR2 frequency range (i.e., the beam sweeping factor pair may be a per-FR2 beam sweeping factor pair, such as an FR2-1 beam sweeping factor pair or an FR2-2 beam sweeping factor pair). In some embodiments, the beam sweeping factor pair may be associated with an FR2 band (i.e., the beam sweeping factor pair may be a per-FR2 band beam sweeping factor pair). In some embodiments, the beam sweeping factor pair may be associated with an FR2 band per band combination (i.e., the beam sweeping factor pair may be a per-FR2 band per band combination beam sweeping factor pair). In some embodiments, the method 200 may determine and report separate beam sweeping factor pairs for different FR2 frequency ranges, different FR2 band, and/or different FR2 band per band combinations.

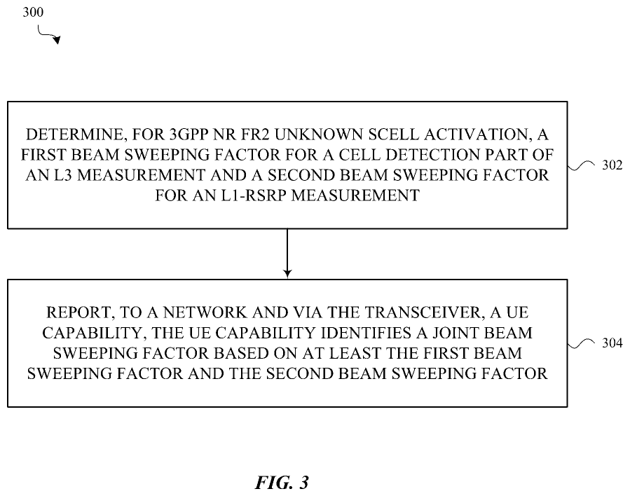

FIG. 3 shows another example method 300 of wireless communication by a UE. In some cases, the UE may be the UE described with reference to FIG. 1 or one of the other UEs described herein. The method 300 may be performed using a processor, a transceiver, or other components of the UE.

At 302, the method 300 may include determining, for a 3GPP NR FR2 SCell activation, a first beam sweeping factor (X1) for a cell detection part of an L3 measurement and a second beam sweeping factor (X2) for an L1-RSRP measurement.

At 304, the method 300 may include reporting, to a network (e.g., to a network device of a RAN, such as a base station or gNB) and via the transceiver, a UE capability. The UE capability may identify a joint beam sweeping factor (Y) based on at least the first beam sweeping factor and the second beam sweeping factor.

In some embodiments, the joint beam sweeping factor may be determined by adding the first beam sweeping factor and the second beam sweeping factor (e.g., as Y=X1+X2). In some embodiments, Y may be limited to eight or sixteen (i.e., Y≤8 or Y≤16). This value of Y may be sufficient for the network because it enables the network to determine the duration of the 3GPP NR FR2 SCell activation measurement period, Y * Tᵣₛ, where Tᵣₛ is the reference signal (RS) periodicity for L3 and L1 measurements. Although the UE may operate in accordance with particular values of X1 and Y1, the network may only need to know how long it will take the UE to train the UE's Rx beams for 3GPP NR FR2 SCell activation, so that the network can delay scheduling the UE until after the Rx beam training is complete.

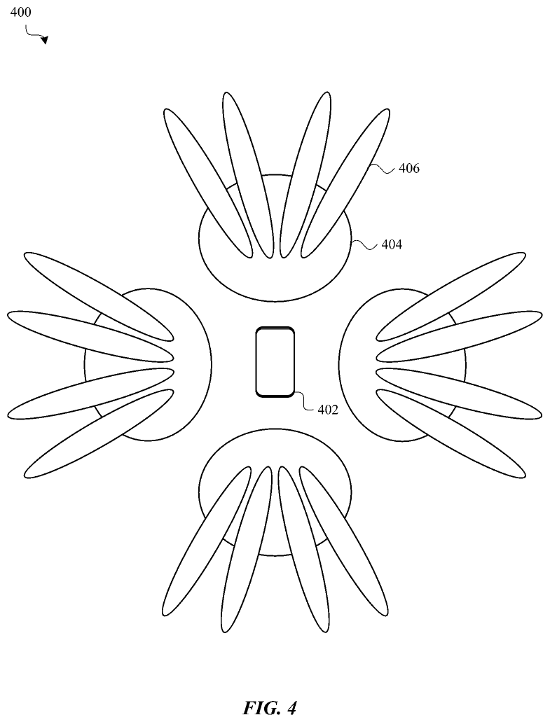

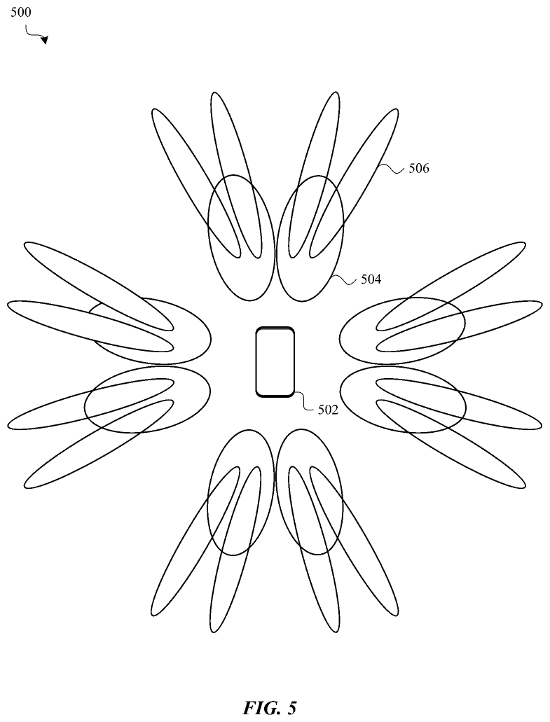

Alternatively, and in some embodiments, the joint beam sweeping factor may be determined by multiplying the first beam sweeping factor by the second beam sweeping factor (e.g., as Y=X1* X2). In some embodiments, Y may be limited to a set of values, such as Y ∈{16, 32, 40, 48, 56, 64}. In these embodiments, the product of the number of Rx beams used for coarse (or rough) beam training pattern (e.g., for L3 measurements) and the number of Rx beams used for fine beam training pattern (e.g., for L1 measurements) may provide sufficient information for the network to determine how much time the UE needs to train the UE's Rx beams for 3GPP NR FR2 SCell activation, as the Y=16 options 400, 500 shown in FIGS. 4 and 5 are equivalent. By way of example, FIG. 4 shows the UE 402 performing beam training using four coarse Rx beams 404 and four fine Rx beams 406 per coarse Rx beam 404 (for Y=16). In contrast, FIG. 5 shows the UE 502 performing beam training using eight coarse Rx beams 504 and two fine Rx beams 506 per coarse Rx beam 504 (for Y=16).

The method 300 may be variously embodied, extended, or adapted, as described in the following paragraphs and elsewhere in this description.

In some embodiments of the method 300, the first beam sweeping factor may be a member of a first list of candidate options (e.g., X1∈{n₁, n₂, n₃. . . } . In some embodiments, each candidate option in the first list of candidate options may be less than or equal to eight (e.g., n₁<n₂<n₃. . . <8). In some embodiments, the second beam sweeping factor may be a member of a second list of candidate options (e.g., X2∈{m₁, m₂, m₃. . . } . In some embodiments, each candidate option in the second list of candidate options may be less than or equal to eight (e.g., m₁<m₂<m₃. . . ≤8). In some embodiments, the number of candidate options in each list of candidate options may be greater or fewer.

In some embodiments of the method 300, the first list of candidate options may include four or fewer candidate options and the second list of candidate options may include four or fewer candidate options (e.g., 1≤i, j≤4). With such a limitation, the number of possible joint beam sweeping factors is sixteen. In other embodiments, each list of candidate options may include more or fewer candidate options, and the number of possible joint beam sweeping factors may be greater or fewer. However, a network device (e.g., a network device of a RAN) must have the resources to support the number of joint possible beam sweeping factors.

In some embodiments of the method 300, the first beam sweeping factor and the second beam sweeping factor may be determined under the constraint that the first beam sweeping factor must be less than the second beam sweeping factor (i.e., X1<X2). In other embodiments, the first beam sweeping factor and the second beam sweeping factor may be determined under the constraint that the second beam sweeping factor must be less than the first beam sweeping factor (i.e., X2<X1). In other embodiments, the first beam sweeping factor and the second beam sweeping factor may be determined under the constraint that the first beam sweeping factor must be equal to the second beam sweeping factor (i.e., X1=X2).

In some embodiments of the method 300, the UE capability may be a capability indication based on 3GPP TS 38.306. For example, and in some embodiments, the joint beam sweeping factor may be associated with the UE (i.e., the joint beam sweeping factor may be a per-UE joint beam sweeping factor). In some embodiments, the joint beam sweeping factor may be associated with an FR2 frequency range (i.e., the joint beam sweeping factor may be a per-FR2 joint beam sweeping factor, such as an FR2-1 joint beam sweeping factor or an FR2-2 joint beam sweeping factor). In some embodiments, the joint beam sweeping factor may be associated with an FR2 band (i.e., the joint beam sweeping factor may be a per-FR2 band joint beam sweeping factor). In some embodiments, the joint beam sweeping factor may be associated with an FR2 band per band combination (i.e., the joint beam sweeping factor may be a per-FR2 band per band combination joint beam sweeping factor). In some embodiments, the method 300 may determine and report separate joint beam sweeping factors for different FR2 frequency ranges, different FR2 band, and/or different FR2 band per band combinations.

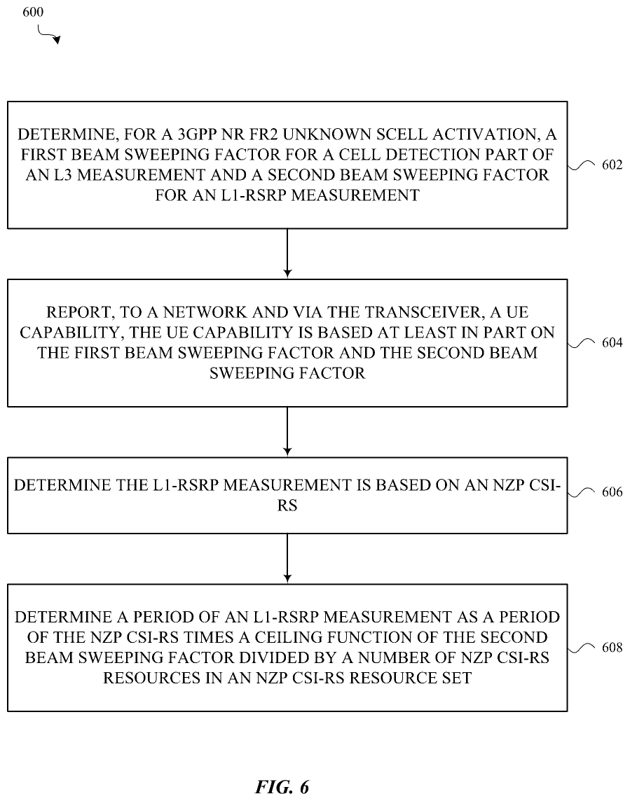

The methods described with reference to FIGS. 2 and 3 may be used by a UE regardless of what RS is measured for L3 and L1 measurements. Often, the UE will measure a CSI-RS for L3 measurements and measure an SSB for L1 measurements. However, there may be special cases when a UE uses an SSB for the cell detection part of an L3 measurement and uses a CSI-RS for L1-RSRP measurement. There may also be special cases when a UE uses one or more types of CSI-RS for both the cell detection part of an L3 measurement and for L1-RSRP measurement. A method that may be performed in these special cases is described with reference to FIG. 6.

FIG. 6 shows another example method 600 of wireless communication by a UE. In some cases, the UE may be the UE described with reference to FIG. 1 or one of the other UEs described herein. The method 600 may be performed using a processor, a transceiver, or other components of the UE.

At 602, the method 600 may include determining, for a 3GPP NR FR2 SCell activation, a first beam sweeping factor (X1) for a cell detection part of an L3 measurement and a second beam sweeping factor (X2) for an L1-RSRP measurement.

At 604, the method 600 may include reporting, to a network (e.g., to a network device of a RAN, such as a base station or gNB) and via the transceiver, a UE capability. The UE capability may be based at least in part on the first beam sweeping factor and the second beam sweeping factor.

At 606, the method 600 may include determining the L1-RSRP measurement is based on a non-zero power (NZP) CSI-RS (NZP CSI-RS).

At 608, the method 600 may include determining a period of an L1-RSRP measurement as a period of the NZP CSI-RS times a ceiling function of the second beam sweeping factor divided by a number of NZP CSI-RS resources in an NZP CSI-RS resource set (e.g., T_{csi-rs} * [X2/N], where T_{csi-rs} is the periodicity of the NZP CSI-RS and N is the number of NZP CSI-RS resources in the NZP CSI-RS resource set).

In various embodiments of the method 600, the UE capability may identify the beam sweeping factor pair described with reference to FIG. 2 or the joint beam seeping factor described with reference to FIG. 3.

The method 600 may be variously embodied, extended, or adapted, as described in the following paragraphs and elsewhere in this description.

In some embodiments, the method 600 may include determining the cell detection part of the L3 measurement is based on an SSB), and determining the maximum number of Rx beams used to measure NZP CSI-RS resources (e.g., the maxNumberRxBeam in 3GPP TS 38.306) is equal to the second beam sweeping factor.

In some embodiments, the method 600 may include determining the cell detection part of the L3 measurement is based on the NZP CSI-RS; determining the NZP CSI-RS for the cell detection part of the L3 measurement is one NZP CSI-RS in a configured NZP CSI-RS resource set with repetition ON in any L1-RSRP configuration; and determining a period of the cell detection part of an L3 measurement as a period of the NZP CSI-RS times a ceiling function of the first beam sweeping factor divided by the number of NZP CSI-RS resources in an NZP CSI-RS resource set (e.g., T_{csi-rs} * [X1/N]).

In some embodiments of the method 600, the NZP CSI-RS may be a first NZP CSI-RS, and the number of NZP CSI-RS resources in the NZP CSI-RS resource set may be a first number of NZP CSI-RS resources in a first NZP CSI-RS resource set. In these embodiments, the method 600 may further include determining the cell detection part of the L3 measurement is based on a second NZP CSI-RS; determining the second NZP CSI-RS for the cell detection part of the L3 measurement is one NZP CSI-RS in a second NZP CSI-RS resource set with repetition ON in any L1-RSRP configuration; and determining a period of the cell detection part of the L3 measurement as a period of the second NZP CSI-RS times a ceiling function of the first beam sweeping factor divided by a second number of NZP CSI-RS resources in the second NZP CSI-RS resource set. In these embodiments, the period of the cell detection part of the L3 measurement may be T_{csi-rs-L3} * [X1/N], where T_{csi-rs-L3} is the periodicity of the NZP CSI-RS for the cell detection part of the L3 measurement. The period of the L1-RSRP measurement may be T_{csi-rs-L1} * [X2/N], where T_{csi-rs-L1} is the periodicity of the NZP CSI-RS for the L1-RSRP measurement.

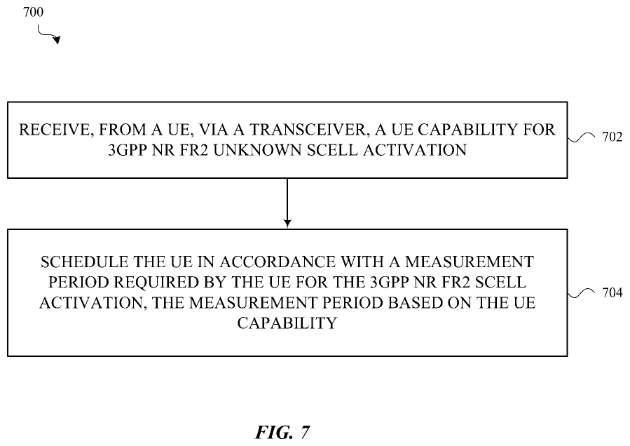

FIG. 7 shows an example method 700 of wireless communication by a network device (e.g., a network device of a RAN). In some cases, the network device may be the network device described with reference to FIG. 1 or one of the other network devices described herein. The method 700 may be performed using a processor, transceiver, or other components of the network device.

At 702, the method 700 may include receiving, from a UE, via the transceiver, a UE capability for 3GPP NR FR2 SCell activation. The UE capability may be based at least in part on a first beam sweeping factor (X1) for a cell detection part of an L3 measurement, and a second beam sweeping factor (X2) for an L1-RSRP measurement.

At 704, the method 700 may include scheduling the UE in accordance with a measurement period required by the UE for the 3GPP NR FR2 SCell activation. The measurement period may be based on the UE capability received at 702.

In various embodiments of the method 700, the UE capability may identify the beam sweeping factor pair described with reference to FIG. 2 or the joint beam seeping factor described with reference to FIG. 3.

The method 700 may be variously embodied, extended, or adapted, as described elsewhere in this description (e.g., as described with reference to FIGS. 2-6).

Embodiments contemplated herein include one or more non-transitory computer-readable media storing instructions to cause an electronic device, upon execution of the instructions by one or more processors of the electronic device, to perform one or more elements of the method 200, 300, 600, or 700. In the context of method 200, 300, or 600, this non-transitory computer-readable media may be, for example, a memory of a UE (such as a memory 906 of a wireless device 902 that is a UE, as described herein). In the context of method 700, this non-transitory computer-readable media may be, for example, a memory of a network device (such as a memory 924 of a network device 920, as described herein).

Embodiments contemplated herein include an apparatus having logic, modules, or circuitry to perform one or more elements of the method 200, 300, 600, or 700. In the context of method 200, 300, or 600, this apparatus may be, for example, an apparatus of a UE (such as a wireless device 902 that is a UE, as described herein). In the context of method 700, this apparatus may be, for example, an apparatus of a network device (such as a network device 920, as described herein).

Embodiments contemplated herein include an apparatus having one or more processors and one or more computer-readable media, using or storing instructions that, when executed by the one or more processors, cause the one or more processors to perform one or more elements of the method 200, 300, 600, or 700. In the context of method 200, 300, or 600, this apparatus may be, for example, an apparatus of a UE (such as a wireless device 902 that is a UE, as described herein). In the context of the method 700, this apparatus may be, for example, an apparatus of a network device (such as a network device 920, as described herein).

Embodiments contemplated herein include a signal as described in or related to one or more elements of the method 200, 300, 600, or 700.

Embodiments contemplated herein include a computer program or computer program product having instructions, wherein execution of the program by a processor causes the processor to carry out one or more elements of the method 200, 300, 600, or 700. In the context of method 200, 300, or 600, the processor may be a processor of a UE (such as a processor(s) 904 of a wireless device 902 that is a UE, as described herein), and the instructions may be, for example, located in the processor and/or on a memory of the UE (such as a memory 906 of a wireless device 902 that is a UE, as described herein). In the context of method 700, the processor may be a processor of a network device (such as a processor(s) 922 of a network device 920, as described herein), and the instructions may be, for example, located in the processor and/or on a memory of the network device (such as a memory 924 of a network device 920, as described herein).

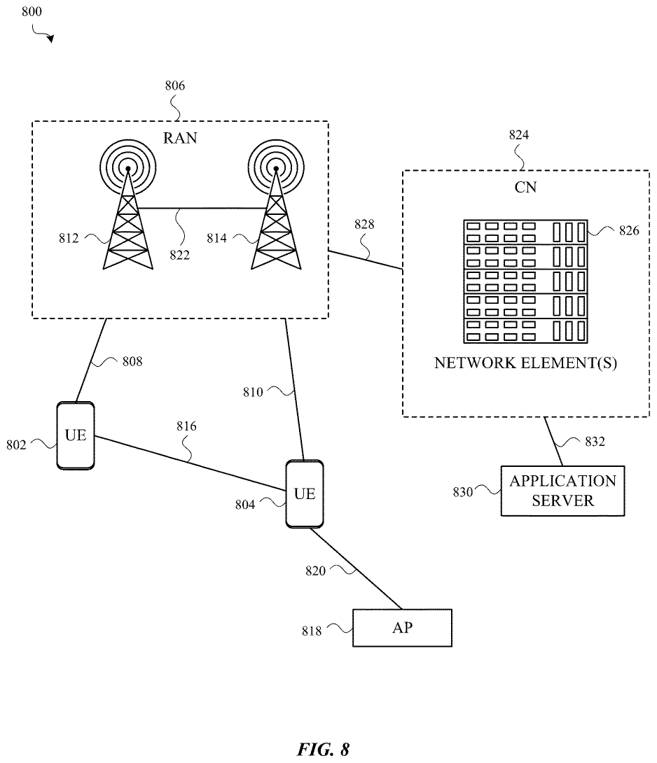

FIG. 8 illustrates an example architecture of a wireless communication system, according to embodiments described herein. The following description is provided for an example wireless communication system 800 that operates in conjunction with the LTE system standards or specifications and/or 5G or NR system standards or specifications, as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more network devices, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more network devices of a RAN (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more network devices of a RAN (e.g., two or more gNBs and the like) that connect to the 5GC, between a base station 812 (e.g., a gNB) connecting to the 5GC and an eNB, and/or between two eNBs connecting to the 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

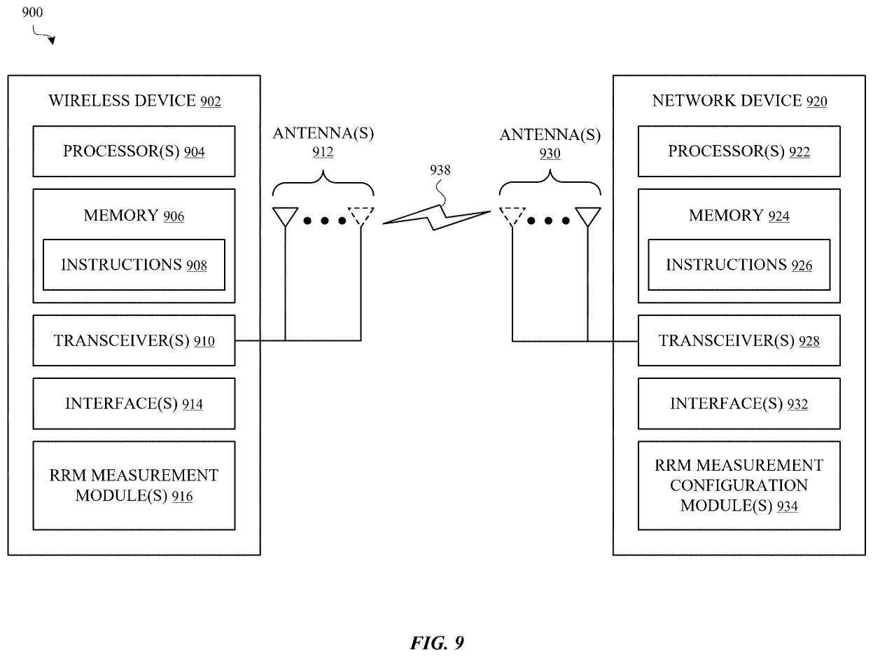

FIG. 9 illustrates an example system 900 for performing signaling 938 between a wireless device 902 and a network device 920, according to embodiments described herein. The system 900 may be a portion of a wireless communication system as herein described. The wireless device 902 may be, for example, a UE of a wireless communication system. The network device 920 may be, for example, a base station (e.g., an eNB or a gNB) or a radio head of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 (also collectively referred to as a transceiver 910) that may include radio frequency (RF) transmitter and/or receiver circuitry that use the antenna(s) 912 of the wireless device 902 to facilitate signaling (e.g., the signaling 938) to and/or from the wireless device 902 with other devices (e.g., the network device 920) according to corresponding RATs.

The wireless device 902 may include one or more antenna(s) 912 (e.g., one, two, four, eight, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include RRM measurement module(s) 916. The RRM measurement module(s) 916 may be implemented via hardware, software, or combinations thereof. For example, the RRM measurement module(s) 916 may be implemented as a processor, circuit, and/or instructions 908 stored in the memory 906 and executed by the processor(s) 904. In some examples, the RRM measurement module(s) 916 may be integrated within the processor(s) 904 and/or the transceiver(s) 910. For example, the RRM measurement module(s) 916 may be implemented by a combination of software components (e.g., executed by a DSP or a general processor) and hardware components (e.g., logic gates and circuitry) within the processor(s) 904 or the transceiver(s) 910.

The RRM measurement module(s) 916 may be used for various aspects of the present disclosure, for example, aspects of FIGS. 1-7, from a wireless device or UE perspective. The RRM measurement module(s) 916 may be configured to, for example, transmit a set of capabilities related to the wireless device's beam sweeping factor capabilities for RRM measurement and/or perform RRM measurements in accordance with the beam sweeping factor capabilities.

The network device 920 may include one or more processor(s) 922. The processor(s) 922 may execute instructions such that various operations of the network device 920 are performed, as described herein. The processor(s) 922 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 (also collectively referred to as a transceiver 928) that may include RF transmitter and/or receiver circuitry that use the antenna(s) 930 of the network device 920 to facilitate signaling (e.g., the signaling 938) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 of a RAN (e.g., a base station, a radio head, etc.) may include interface(s) 932 made up of transmitters, receivers, and other circuitry (e.g., other than the transceiver(s) 928/antenna(s) 930 already described) that enables the network device 920 to communicate with other equipment in a network, and/or that enables the network device 920 to communicate with external networks, computers, databases, and the like for purposes of operations, administration, and maintenance of the network device 920 or other equipment operably connected thereto.

The network device 920 may include one or more RRM measurement configuration module(s) 934. The RRM measurement configuration module(s) 934 may be implemented via hardware, software, or combinations thereof. For example, the RRM measurement configuration module(s) 934 may be implemented as a processor, circuit, and/or instructions 926 stored in the memory 924 and executed by the processor(s) 922. In some examples, the RRM measurement configuration module(s) 934 may be integrated within the processor(s) 922 and/or the transceiver(s) 928. For example, the RRM measurement configuration module(s) 934 may be implemented by a combination of software components (e.g., executed by a DSP or a general processor) and hardware components (e.g., logic gates and circuitry) within the processor(s) 922 or the transceiver(s) 928.

The RRM measurement configuration module(s) 934 may be used for various aspects of the present disclosure, for example, aspects of FIGS. 1-7, from a network device perspective. The RRM measurement configuration module(s) 934 may be configured to, for example, receive a set of capabilities related to the wireless device's beam sweeping factor capabilities for RRM measurement and/or schedule the wireless device 902 in accordance with the beam sweeping factor capabilities.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising a memory coupled to a processor, the processor configured to:
determine, for a 3rd Generation Partnership Project (3GPP) new radio (NR) frequency range two (FR2) unknown secondary cell (SCell) activation,
a first beam sweeping factor for a cell detection part of a Layer 3 (L3) measurement; and
a second beam sweeping factor for a Layer 1 (L1) reference signal received power (RSRP) (L1-RSRP) measurement; and
report a UE capability to a network, the UE capability is based at least in part on the first beam sweeping factor and the second beam sweeping factor.

2.-20. (canceled)

21. The apparatus of claim 21 wherein the UE capability identifies a beam sweeping factor pair including the first beam sweeping factor and the second beam sweeping factor.

22. The apparatus of claim 21, wherein:
the processor is configured to map the beam sweeping factor pair to an index; and
reporting the UE capability comprises reporting the index identifying the beam sweeping factor pair.

23. The apparatus of claim 21, wherein:
the beam sweeping factor pair is associated with one of:
the apparatus;
an FR2 frequency range;
an FR2 band; or
an FR2 band per band combination.

24. The apparatus of claim 1, wherein the processor is configured to:
determine the first beam sweeping factor based on a synchronization signal block (SSB) configuration and the second beam sweeping factor based on a non-zero power (NZP) channel state information reference signal (CSI-RS) configuration.

25. The apparatus of claim 1, wherein the processor is configured to determine the first beam sweeping factor and the second beam sweeping factor based on a measurement period required by the apparatus for the unknown SCell activation.

26. The apparatus of claim 1, wherein the UE capability identifies a joint beam sweeping factor, the joint beam sweeping factor determined by adding the first beam sweeping factor and the second beam sweeping factor.

27. The apparatus of claim 1, wherein the UE capability identifies a joint beam sweeping factor, the joint beam sweeping factor determined by multiplying adding the first beam sweeping factor and the second beam sweeping factor.

28. The apparatus of claim 1, wherein:
the first beam sweeping factor is a member of a first list of candidate options, each candidate option in the first list of candidate options less than or equal to eight; and
the second beam sweeping factor is a member of a second list of candidate options, each candidate option in the second list of candidate options less than or equal to eight.

29. The apparatus of claim 28, wherein:
the first list of candidate options includes four or fewer candidate options; and
the second list of candidate options includes four or fewer candidate options.

30. The apparatus of claim 1, wherein:
the first beam sweeping factor and the second beam sweeping factor are determined under a constraint of:
the first beam sweeping factor must be less than the second beam sweeping factor;
the second beam sweeping factor must be less than the first beam sweeping factor; or
the first beam sweeping factor must be equal to the second beam sweeping factor.

31. The apparatus of claim 1 wherein the processor is configured to:
determine the L1-RSRP measurement is based on an NZP CSI-RS; and
determine a period of an L1-RSRP measurement as a period of the NZP CSI-RS times a ceiling function of the second beam sweeping factor divided by a number of NZP CSI-RS resources in an NZP CSI-RS resource set.

32. The apparatus of claim 31 wherein the processor is configured to:
determine the cell detection part of the L3 measurement is based on an SSB; and
determine a maximum number of receive (Rx) beams used to measure NZP CSI-RS resources is equal to the second beam sweeping factor.

33. The apparatus of claim 31 wherein the processor is configured to:
determine the cell detection part of the L3 measurement is based on the NZP CSI-RS;
determine the NZP CSI-RS for the cell detection part of the L3 measurement is one NZP CSI-RS in a configured NZP CSI-RS resource set with repetition ON in any L1-RSRP configuration; and
determine the period of the cell detection part of the L3 measurement as a period of the NZP CSI-RS times a ceiling function of the first beam sweeping factor divided by the number of NZP CSI-RS resources in an NZP CSI-RS resource set.

34. The apparatus of claim 31, wherein:
the NZP CSI-RS is a first NZP CSI-RS;
the number of NZP CSI-RS resources in the NZP CSI-RS resource set is a first number of NZP CSI-RS resources in a first NZP CSI-RS resource set; and
the processor is configured to:
determine the cell detection part of the L3 measurement is based on a second NZP CSI-RS;
determine the second NZP CSI-RS for the cell detection part of the L3 measurement is one NZP CSI-RS in a second NZP CSI-RS resource set with repetition ON in any L1-RSRP configuration; and
determine a period of the cell detection part of the L3 measurement as a period of the second NZP CSI-RS times a ceiling function of the first beam sweeping factor divided by a second number of NZP CSI-RS resources in the second NZP CSI-RS resource set.

35. A method for reporting a UE capability to a network for a 3GPP NR FR2 unknown SCell activation, the method comprising:
determining a first beam sweeping factor for a cell detection part of an L3 measurement;
determining a second beam sweeping factor for an L1-RSRP measurement; and
reporting the UE capability to the network, the UE capability being based on the first beam sweeping factor and the second beam sweeping factor.

36. The method of claim 35, wherein the UE capability identifies a beam sweeping factor pair including the first beam sweeping factor and the second beam sweeping factor.

37. The method of claim 36, further comprising:
mapping the beam sweeping factor pair to an index; and
reporting the UE capability by reporting the index identifying the beam sweeping factor pair.

38. The method of claim 35, wherein:
the first beam sweeping factor is determined based on an SSB configuration; and
the second beam sweeping factor is determined based on an NZP CSI-RS configuration.

39. The method of claim 35, wherein the UE capability identifies a joint beam sweeping factor, the joint beam sweeping factor being calculated from the first beam sweeping factor and the second beam sweeping factor.
